(19) United States
(12) Patent Application Publication
(10) Pub. No.: US 2003/0129437 A1
(43) Pub. Date: Jul. 10, 2003

(54) Composite material and method of making the same

(75) Inventors: Kenichi Kawaguchi, Shizuoka (JP); Makoto Katsumata, Shizuoka (JP); Tatsuya Kato, Shizuoka (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/323,724

(22) Filed: Dec. 20, 2002

(30) Foreign Application Priority Data
Dec. 25, 2001 (JP) P2001-391693

(51) Int. Cl. B32B 15/04

(52) U.S. Cl. 428/545; 428/469; 164/97; 428/293.1

(57) ABSTRACT

The invention is to offer a composite material with least uneven distribution of a mechanical strength resulted from dispersing conditions of an inorganic filler and having a by far high mechanical strength in comparison with conventional composite materials, as well as to offer a method of making the same. Inorganic hollow particles and at least one of inorganic fiber sheets are accommodated in a stacked manner within a casting mold, and a molten metal is poured into a casting mold while pressurizing it, followed by cooling, whereby it is possible to produce such a composite material where a first composite layer and a second composite layer continuously exist in a metal matrix, so as to compose a composite material being a single body as a whole, the first composite layer containing at least one of inorganic fiber sheets and the second composite layer containing inorganic hollow particles.

The present application is based on Japanese Patent Application No. 2001-391693, the entire contents of which are incorporated herein by reference.

### BACKGROUND OF THE INVENTION

1. Field of the Invention

The present invention relates to a composite material with a metal matrix, including inorganic fiber sheets such as cloth or felt and inorganic hollow particles.

2. Related Art

Such composite materials have conventionally been used which are scattered with inorganic fillers such as inorganic fibers or inorganic hollow particles in a metal matrix, aiming at improving mechanical strength of materials or lightening weight thereof. For example, Japanese Unexamnined Patent Publications S48-22327A and S55-22182A describe composite materials scattered with hollow vitreous Shirasu balloons in a metal matrix such as aluminum. Japanese Unexamnined Patent Publication No. H11-29831 describes a composite material scattered with ceramic hollow particles, inorganic fibers and ceramic particles in the metal matrix.

In general, these composite materials are produced by placing an inorganic filler in a casting mold and pouring a molten metal into the casting mold while pressurizing it, but then since difference in specific gravity of the inorganic filler and the metal is large, the inorganic filler goes up in the molten metal, the composite material has easily segregation of the inorganic filler to one side. In the composite material containing both of inorganic hollow particles and inorganic fibers as the inorganic filler, since the specific gravity also exists therebetween, the dispersing condition is made worse. Due to the segregation of the inorganic filler, a mechanical strength is unevenly distributed depending on parts of the composite material, and this uneven distribution is a large obstacle against production of a desired mechanical strength.

### SUMMARY OF THE INVENTION

In view of the above mentioned situations, the invention has been made, and accordingly it is an object of the invention to offer a composite material with least uneven distribution of the mechanical strength resulted from dispersing conditions of the inorganic filler and having a by far high mechanical strength in comparison with conventional composite materials, as well as to offer a method of making the same.

(1) For accomplishing the above mentioned object, the invention is to offer such a composite material comprising:

a first composite layer including a metal matrix and at least one of inorganic fiber sheets and

a second composite layer including the metal matrix and inorganic hollow particles;

wherein the first composite layer and the second composite layer continuously provided in the composite material so as to constitute a single body.

(2) Further in the above composite material, the inorganic fiber sheets, the inorganic hollow particles and the metal matrix exist in a mixed manner in a vicinity of a boundary between the first composite layer and second composite layer.

(3) For accomplishing the same object, the invention is to offer the composite material, in the above mentioned, wherein a layer composed of a metal forming the metal matrix exists continuously from the first composite layer or the second composite layer.

(4) Still for accomplishing the same object, the invention is to offer a method of making the composite material, comprising the steps of accommodating inorganic hollow particles and at least one of inorganic fiber sheets in a stacked manner within a casting mold, and pouring a molten metal into the casting mold while pressurizing it, followed by cooling.

(5) Yet for accomplishing the same object, the invention is to offer a method of making the composite material, comprising the steps of pouring a molten metal within a casting mold to be at a predetermined height, subsequently accommodating inorganic hollow particles and at least one of inorganic fiber sheets in a stacked manner on a surface of the molten metal, pouring the same molten metal as the molten metal into the casting mold while pressurizing it, followed by cooling.

### BRIEF DESCRIPTION OF THE DRAWINGS

FIG. 1 is a cross sectional view showing the first embodiment of the composite material according to the invention;

FIG. 2 is a schematic view showing one embodiment of the casting apparatus suited to production of the composite material according to the invention;

FIG. 3 is a cross sectional view showing the second embodiment of the composite material according to the invention; and

FIG. 4 is a cross sectional view showing the third embodiment of the composite material according to the invention.

### DETAILED DESCRIPTION OF THE PREFERRED EMBODIMENTS

The invention will be explained in detail referring to the attached drawings.

(First Embodiment)

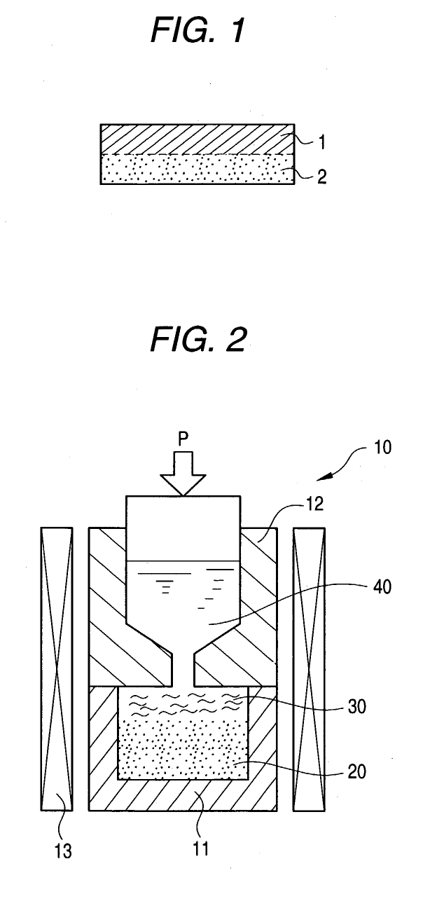

The composite material of the invention is, as shown with a cross sectional view in FIG. 1, that the first composite layer 1 and the second composite layer 2 continuously exist in the metal matrix so as to compose a composite material being the single body as a whole, the first composite layer containing at least one of cloth and felt of the inorganic fiber and the second composite layer containing inorganic hollow particles. A boundary (shown with a dotted line) between the first material layer and the second material layer is not distinctly partitioned, but in a vicinity of the boundary, inorganic fiber sheets, inorganic hollow particles and metals exist in a mixed manner.

Sorts of the inorganic fibers are not especially limited, and those having conventionally been used for compounding with metals may be employed. For instance, various kinds of ceramic fibers such as alumina fiber, alumina silica fiber, mullite fiber, silicon carbide fiber, silicon nitride fiber, aluminum boride fiber, potassium titanate fiber, carbon fiber, or rock fiber may be served in response to purposes or usage As to form of the sheets, cloth or felt may be used. Further such the sorts of sheet may be used solely or in combination. In the present invention, a cloth is used for an inorganic fiber sheet 30.

Sorts of the inorganic hollow particles are not especially limited either, and those having conventionally been used for compounding with metals may be employed. For instance, alumina, silica, hollow particles composed of mullite, or Shirasu balloons may be served in response to purposes or usage.

Further, sorts of metals are not especially limited, and aluminum or aluminum based alloys, copper or copper-based alloys may be appropriately selected to use in response to purposes or usage.

For producing the first composite layer, for example, a casting apparatus 10 shown in FIG. 2 is used. The casting apparatus 10 is composed of main members being a casting mold 11, a melting crucible 12, and a heater 13 for heating the casting mold 11 and the melting crucible 12. For production, the inorganic hollow particles 20 are firstly charged at a predetermined amount within the casting mold 11, on which the inorganic fiber sheets 30 are laid at a predetermined thickness. Incidentally, the thickness of the inorganic fiber sheets 30 and the amount of the inorganic hollow particles 20 are relatively selected in relation with the amount of the molten metal 40, taking a degree of lightening the composite material or the mechanical strength into consideration.

Next, the melting crucible 12 is mounted on the casting mold 11, and a metal clod becoming a matrix is thrown into the melting crucible 12. Then, the heater 13 heats it into a molten metal 40, and subsequently, the molten metal 40 is poured into the casting mold 11, while the molten metal 40 is effected with pressure on the surface as shown with “P” by means of an appropriate instrument, for example, gas pressure by N or Ar gas or oil pressure. Thereby, the molten metal 40 enters into a space between the inorganic fiber sheets 30 and the inorganic hollow particles 20, and fill the interior of the casting mold 11. At this time, the conventional composites was involved with a problem that the inorganic hollow particles 20 went up in the molten metal 40 and did not evenly disperse into the metal matrix, but in the composite material of the invention, since the inorganic fiber sheets 30 suppress the inorganic hollow particles 20 from floating, the second material layer 2 of the composite material to be produced is evenly scattered with the inorganic hollow particles 20. Then, heating by the heater 13 is stopped and the casting mold 11 is cooled, whereby the composite material is obtained.

(Second Embodiment)

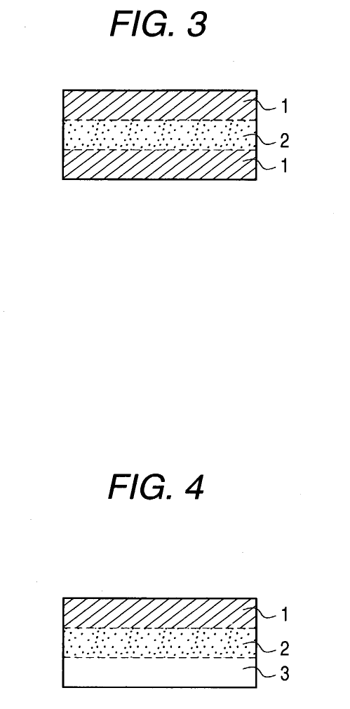

In the above first embodiment, each of the first composite layer 1 and the second composite layer 2 is not necessary a layer one by one, for example, as shown in FIG. 3, the first composite layer 1 is two sheets and the second composite layer 2 is kept between the two sheets to make a composite material of three layers.

For producing the composite material shown in FIG. 3, by use of the casting apparatus 10 shown in FIG. 2, the inorganic fiber sheets 30 are spread all over the casting mold 11, on which the inorganic hollow particles 20 is charged, and on which the inorganic fiber sheets 30 are further laid to be three layered structure, and the molten metal 40 is poured into the casting mold 11.

(Third Embodiment)

In the above first embodiment, a layer made of the metal forming a further matrix may be provided. Namely, as shown in FIG. 4, in addition to the first composite layer 1 and the second composite layer, it is possible to make a composite material of three layered structure having a metal layer 3 continuing to the second material layer 2.

For producing the composite material shown in FIG. 4, by use of the casting apparatus 10 shown in FIG. 2, the molten metal 40 is in advance poured into the casting mold 40 to be a predetermined depth, on the surface of which the inorganic hollow particles 20 is filled, and further on which the inorganic fiber sheets 30 are laid to be three layered structure, and the molten metal 40 is poured into the casting mold 11.

### EXAMPLE

### Example 1 and Comparative Example 1

By use of the casting apparatus shown in FIG. 2, hollow particles made of mullite were charged into the casting mold, on which an alumina-made cloth was laid, and a molten aluminum alloy was poured and cooled to be a composite material A. For comparison, the mullite-made hollow particles of the same amount were charged, and a molten aluminum alloy was poured and cooled to be a composite material B.

When observing the obtained composite materials A and B in the cross section, in the composite material A, the first composite layer containing the cloth shown in FIG. 1 and the second composite layer containing the hollow particles continuously existed, and besides, in the second composite layer, the hollow particles evenly dispersed in the metal matrix. On the other hand, in the composite material B, the hollow particles unevenly dispersed to one side.

The invention has been explained in detail as above, and is not limited to any of the embodiments, but various modifications are available. For instance, in the three layered structure as shown in FIG. 3, it is possible that the first composite layer 1 and the second composite layer 2 are made plural to be laminated alternately for making more multi-layered composite material. Similarly also in the composite material containing the metal layer as shown in FIG. 4, structures of more multi-layers are possible.

As mentioned above, according to the invention, it is possible to offer such a composite material with least uneven distribution of the mechanical strength resulted from dispersing conditions of the inorganic filler and having a by far high mechanical strength in comparison with conventional composite materials through the simple method.

What is claimed is:

1. A composite material comprising:
a first composite layer including a metal matrix and at least one inorganic fiber sheets and
a second composite layer including the metal matrix and inorganic hollow particles;
wherein the first composite layer and the second composite layer continuously provided in the composite material so as to constitute a single body.

2. A composite material as set forth in claim 1, wherein the inorganic fiber sheets, the inorganic hollow particles and the metal matrix exist in a mixed manner in a vicinity of a boundary between the first composite layer and second composite layer.

3. A composite material as set forth in claim 1, wherein a layer composed of a metal forming the metal matrix exists continuously from the first composite layer or the second composite layer.

4. A method of making a composite material, comprising the steps of:
accommodating inorganic hollow particles and at least one of inorganic fiber sheets within a casting mold;
pouring a molten metal while pressurizing into the casting mold in which the inorganic fibers and the inorganic fiber sheets are accommodated; and
cooling the molten metal.

5. A method of making a composite material, comprising the steps of:
pouring a molten metal within a casting mold to be at a predetermined height;
accommodating inorganic hollow particles and at least one of inorganic fiber sheets in a stacked manner on a surface of the molten metal in the casting mold;
further pouring the molten metal into the casting mold while pressurizing; and
cooling the molten metal.
